(19) United States
(12) Patent Application Publication
(10) Pub. No.: US 2025/0331573 A1
(43) Pub. Date: Oct. 30, 2025

(54) AEROSOL-GENERATING DEVICE WITH ENCRYPTED DATA MANAGEMENT

(71) Applicant: Philip Morris Products S.A., Neuchatel (CH)

(72) Inventors: Robin FARINE, Auvernier (CH); Andrew James MCLAUCHLAN, Poliez-Le-Grand (CH)

(73) Assignee: Philip Morris Products S.A., Neuchatel (CH)

(21) Appl. No.: 18/860,773

(22) PCT Filed: May 22, 2023
(86) PCT No.: PCT/EP2023/063563

§ 371 Date: Oct. 28, 2024

(30) Foreign Application Priority Data
Jun. 24, 2022 (EP) 22181048.4

(51) Int. Cl. A24F 40/65; A24F 40/50; H04L 9/08; H04L 9/32; H04L 9/40

(52) U.S. Cl. CPC A24F 40/65; A24F 40/50; H04L 9/0861; H04L 9/3242; H04L 63/0428

(57) ABSTRACT

An aerosol-generating device is provided, including: a storage component having stored therein a secret value generated during a manufacturing stage of the device and a unique identification value; a communication component; and a controller configured to: create usage data indicative of usage of the device, derive an encryption key from at least the stored secret value, encrypt the created usage data with the derived encryption key, store the encrypted usage data in the storage component, and transmit the encrypted usage data and the unique identification value via the communication component to an external device, the unique identification value identifying the secret value used for deriving the encryption key. An aerosol-generating system including the aerosol-generating device, a database, and a server is also provided. A method for operating the aerosol-generating device is also provided. A method for transmitting usage data from the aerosol-generating device to a host is also provided.

The present disclosure relates to aerosol-generating devices, and in particular to aerosol generating devices that create, store, and transmit usage data, as well as to systems comprising aerosol-generating devices and a server, methods for operating an aerosol-generating device, methods for transmitting data from an aerosol-generating device to a server, and methods for manufacturing an aerosol-generating device.

Aerosol-generating devices, such as electronic cigarettes or reduced-risk devices that generate an inhalable aerosol by heating a liquid or solid precursor material, create and store usage data during operation. Usage data may pertain both to the functional operation and status of the device and to the consumer usage of the device. Examples include aerosol generation, temperature, battery levels, events, and errors. Some of this data may be communicated to manufacturer servers.

There are several reasons why a protection of the thus created usage data is desirable. First of all, data protection regulations may stipulate measures for protecting the customer's privacy. Moreover, ensuring the confidentiality of the functional information protects the manufacturer from giving a competitor an insight into how the device functions or how it is performing. It also enables to avoid opening the manufacturer ecosystem to malicious or poor-quality third-party services which diminish the customer's experience. Further, ensuring the integrity and authenticity of the data collected at the manufacturer servers protects these servers from being polluted with false or corrupt information uploaded either maliciously or by accident.

Hence, there is a need to protect the data stored in aerosol-generating devices and to ensure the confidentiality of the data records, both inside the device and upon external transmission. Furthermore, there is a need to protect servers collecting data from aerosol- generating devices from being polluted with false or corrupted information.

There is a multitude of cryptographic algorithms known in the art for data encryption, decryption and authentication. Many of these algorithms are at least either one of computationally complex, not suitable for implementation in embedded systems, or insecure.

It is an object of the present invention to provide an aerosol-generating device capable of protecting its usage data without undue increase in complexity and manufacturing cost and without any restrictions to usability, as well as a corresponding method and system.

This is achieved by the features of the independent claims. Preferred embodiments are subject matter of the dependent claims.

It is the particular approach of the present invention to provide each aerosol-generating device with a unique identifier and a secret value, which are stored within the device. At least the secret value is used by the device for deriving an encryption key for encrypting its usage data. The encrypted usage data and the unique identifier may be transmitted to a manufacturer server. The manufacturer server has access to a database which stores the secret value in association with the unique identifier. The manufacturer server may thus retrieve the secret value from the database and derive the encryption key for decrypting the encrypted usage data transmitted from the device.

According to a first aspect of the present invention, there is provided an aerosol-generating device that comprises a storage unit having stored therein a secret value and a unique identification value. The aerosol-generating device further comprises a communication unit and a controller. The controller is configured to create usage data indicative of usage of the aerosol-generating device, to derive an encryption key from at least the stored secret value and, optionally, the unique identification value, to encrypt the created usage data with the derived encryption key, to store the encrypted usage data in the storage unit, and to transmit the encrypted usage data and the unique identification value via the communication unit to an external device.

According to a second aspect of the present invention, there is provided a method for operating an aerosol-generating device. The method comprises the steps of storing a secret value and a unique identification value in a storage unit of the aerosol generating device, creating usage data indicative of usage of the aerosol-generating device, deriving an encryption key from at least the stored secret value and, optionally, the unique identification value, encrypting the created usage data with the derived encryption key, storing the encrypted usage data in the storage unit, and transmitting the encrypted usage data and the unique identification value via a communication unit to an external device.

By deriving the encryption key from a secret value stored in the aerosol-generating device, no complex protocols for the exchange of keys between the aerosol-generating device and an external device, such as a manufacturer server, need to be implemented. Storing a unique identification value within the aerosol-generating device and transmitting same to the external device together with the encrypted usage data allows the external device to derive the appropriate encryption key even if different aerosol-generating devices use different encryption keys for encrypting their usage data. Using different encryption keys for different aerosol-generating devices guarantees that the encrypted usage data of an aerosol-generating device remains safe even in case that another aerosol-generating device is broken or its secret value is leaked.

The term “derive” is used herein to refer to obtaining or determining “A” (e.g. an encryption key) from “B” (e.g. a secret value). In one example, “A” is derived directly from “B”, for instance where “A” equals “B”, or at least a part of “B”. In another example, “A” is derived indirectly from “B”, for instance by performing an operation on “B” to obtain “A”.

Preferably, the controller and/or the method is further adapted to derive an authentication key from at least the secret value and, optionally, the unique identification value, and to authenticate the stored usage data with the derived authentication key.

Providing the usage data with a (cryptographic) authentication code allows for an authentication of the usage data and a detection of deliberate or accidental modifications. By deriving the authentication key from the secret value stored in the aerosol-generating device, no additional protocols for providing each aerosol-generating device with a dedicated authentication key are needed.

Preferably, the unique identification value comprises at least one of a product identifier, a platform identifier, a unique device identifier and a manufacturing site identifier.

Providing, as the unique identification value, product-related information instead of or in combination with a unique device identifier, such as a serial number, allows the external device to readily understand what kind of aerosol-generating device it is communicating with.

Preferably, the secret value is a random value generated during a manufacturing stage of the aerosol-generating device.

Using a random number as the secret value has the advantage that the secret value of an aerosol-generating device cannot be derived from a (leaked) secret value of another aerosol-generating device, thus further hardening the system against possible cryptographic attacks. Generating the secret value during a manufacturing stage of the aerosol-generating device allows that appropriate precautions are taken in order to secure this piece of sensitive information.

Preferably, the aerosol-generating device further comprises a sensor for detecting an operational state of the aerosol-generating device. The controller and/or the method may thus be adapted to create the usage data based on the detected operational state. Various types of sensor may be used, in particular a sensor configured for detecting a user interaction with the aerosol-generating device, a sensor configured for detecting a puff performed by a user of the aerosol-generating device, a sensor configured for detecting a voltage, a current, a resistance, a charge, an energy or a temperature related to an aerosol generating unit of the aerosol-generating device, a sensor for detecting a voltage, a current, a resistance, a charge, an energy or a temperature related to a power supply of the aerosol-generating device, a sensor for detecting a voltage, a current, a resistance, a charge, an energy or a temperature related to a charging device connected to the aerosol-generating device, and/or a sensor for detecting a type or an amount of a consumable material used by the aerosol generating unit.

Different types of sensor thus allow different kinds of usage information to be detected that may be relevant for the user and/or the manufacturer. For example, the usage data may comprise an indication of at least one of
a start time, a duration, an end time, or a type of a user interaction,
a start time, a duration, or an end time of a puff or a number of puffs performed by a user of the aerosol-generating device,
a start time, a duration, or an end time of a charging operation or a number of charging operations performed by the user by connecting the aerosol-generating device to a charging device,
a voltage, a current, a resistance, a charge, an energy or a temperature related to an aerosol generating unit of the aerosol-generating device at a start of a puff, during the puff, or at the end of a puff performed by a user of the aerosol-generating device,
a voltage, a current, a resistance, a charge, an energy or a temperature related to a power supply of the aerosol-generating device at a start of a puff, during the puff, or at the end of the puff performed by a user of the aerosol-generating device,
a voltage, a current, a resistance, a charge, an energy or a temperature related to the power supply of the aerosol-generating device at a start of a charging operation, during the charging operation, or at the end of the charging operation,
a type or an amount of a consumable material used by the aerosol generating unit.

Preferably, the controller and/or the method is adapted to store the encrypted usage data in a payload section of a data record. Each data record may comprise a header, the payload section, and an authentication section. Further, each header may comprise a first data field indicating a format of the data record and a second data field indicating a length of the data record.

Using a predefined data format for storing and/or transmitting the usage data allows the definition of a software interface between the aerosol-generating device and the external device, so that software on the side of the aerosol-generating device and the side of the external device can be developed and maintained independently of each other. Moreover, different types of aerosol generating device may use the same data format, thus improving inter-operability of different devices.

Preferably, each data record may also be associated with a record index. The record index may thus be used for managing a plurality of different data records stored within the aerosol-generating device. The record index may also be used as (a part of) a unique identifier (Record Unique Identity, RUID) for each data record transmitted from the aerosol-generating device to the external device.

Preferably, each header further comprises a third data field indicating how many times a record index has rolled over. In this manner, each data record is uniquely identified, even if the record index is only used internally by the aerosol-generating device for managing the data records and if some of the old data records were already overwritten by more recent data records.

Preferably, the controller and/or the method is adapted to employ a symmetric-key algorithm for encrypting the created usage data. Preferably, AES is employed as the symmetric-key algorithm.

Symmetric-key algorithms are significantly less complex than algorithms that are based on asymmetric keys, both in terms of key generation/distribution and encryption/decryption. Among the conventional symmetric-key algorithms, AES is a well-established algorithm that is particularly suitable for implementation in embedded systems.

Preferably, the controller and/or the method is adapted to derive an initialization vector from the secret value and/or the unique identification value, and to encrypt the created usage data by applying a block cipher in counter mode using the encryption key and the initialization vector.

Applying a block cipher in counter mode is a secure method for applying a block cypher to variable-length data blocks and allows for a low-complexity implementation both at the encryption and the decryption side. By deriving the initialization vector for counter mode from the secret value and/or the unique identification value no additional information needs to be stored and/or transmitted.

Preferably, the controller and/or the method is adapted to employ a hash-based key derivation function, HKDF, for deriving the initialization vector from the secret value and/or the unique identification value. Specifically, the controller and/or the method may preferably be adapted to derive the initialization vector from the secret value and/or the unique identification value with a salt that comprises at least one of a predefined value, a value of a record index associated with a data record containing the created usage data, a type of the data record, and at least part of a message authentication code, MAC, computed for the created usage data.

HKDFs provide a secure means for deriving key material with arbitrary length from a limited-length input key material. Security is further improved by using a salt that comprises a predefined value, and in particular by using a salt that comprises at least one of a value of a record index associated with a data record containing the created usage data, a type of the data record, and at least part of a message authentication code, MAC, computed for the created usage data. In this manner, different initialisation vectors are used for different data records, thus further hardening the system against cryptoanalysis by dramatically reducing the amount of cipher text that is encrypted with the same key. Ensuring that the initialization vector is derived or constructed from properties of the payload protects against generating a repeated initialization vector in the case of an attack which might succeed in forcing a repeated record index or unique record identifier (RUID).

Preferably, the controller and/or the method is adapted to authenticate the created usage data by computing a message authentication code, MAC, for the created usage data. Specifically, the controller and/or the method may be configured to compute the MAC for the created usage data from the created usage data and from a first authentication key.

Computing a MAC for the created usage data, i.e., the usage data in plain text, allows the MAC to be used as an additional input to the key derivation function, thus ensuring that different keys and/or initialization vectors are used for different items of usage data.

Preferably, the controller and/or the method is adapted to authenticate the encrypted usage data by computing a MAC for the encrypted usage data. Specifically, the controller and/or the method may be adapted to compute the MAC for the encrypted usage data from the encrypted usage data and from a second authentication key. The controller and/or the method may also be adapted to compute the MAC for the encrypted usage data from the encrypted usage data, from the MAC for the created usage data, and from the second authentication key.

Computing a MAC for the encrypted usage data, instead of or in addition to a MAC for the plain-text usage data, further hardens the system against cryptoanalysis, because tampered data records can be detected already before decryption. In this manner, crypto-attacks based on manipulated cypher texts can be thwarted. Computing the MAC for the encrypted usage data not only from the encrypted usage data and the second authentication key, but also from the MAC for the created usage data, further improves security against spoofing attacks by allowing the MAC for the created usage data to be authenticated as well.

Preferably, the controller and/or the method is adapted to derive the first authentication key and/or the second authentication key from the secret value and/or the unique identification value.

By deriving the authentication keys from the secret value stored in the aerosol-generating device, no additional protocols for providing each aerosol-generating device with a dedicated authentication key are needed.

Preferably, the controller and/or the method is adapted to employ a hash function for computing the MAC for the created usage data and/or the MAC for the encrypted usage data. Moreover, the controller and/or the method may be further adapted to compute the MAC for the created usage data and/or the MAC for the encrypted usage data by truncating an output of a hash function to a predefined number of bytes. Further, the controller and/or the method may be further adapted to store the MAC for the created usage data and/or the MAC for the encrypted usage data together with the encrypted usage data in the storage unit.

Using a limited number of bytes, in particular two bytes, three bytes or four bytes, truncated from the output of a hash function as the MAC for the created usage data and/or the MAC for the encrypted usage data provides an optimal compromise between the amount of extra storage capacity required for storing the MAC and the level of security that can be achieved for tamper-proofing the usage data.

Preferably, the controller and/or the method is adapted to employ a hash-based key derivation function, HKDF, for deriving, from the secret value and/or the unique identification value, at least one of the encryption key for encrypting the created usage data, the initialization vector for encrypting the created usage data with a block cipher in counter mode, and the authentication key for authenticating the usage data. Specifically, at least part of the secret value and/or the unique identification value may be used as an input key material for the key derivation function.

A hash-based key derivation function is a particularly efficient means for deriving cryptographically secure keys from a limited amount of input key material. Involving at least part of the secret value and/or the unique identification value into the process for deriving the encryption key, the initialization vector or the authentication key guarantees that each aerosol-generating device uses a different key for encrypting and/or authenticating its user data. The overall security of a system comprising a plurality of aerosol-generating devices is thus significantly improved by reducing the amount of cipher text that is encoded and/or authenticated with the same key.

Preferably, a salt is used together with the at least part of the secret value and/or the unique identification value as the input key material for the key derivation function. Further, a fixed salt may be used for deriving the encryption key and/or the authentication key.

Using a salt, i.e., random data that is used as an additional input to the hash function, further improves cryptographic security, in particular by hardening the system against attacks based on pre-computed hash chains.

Preferably, a predefined subset of a bit representation of the secret value may be used, together with the unique identification value and a salt, as the input key material for the key derivation function. Further, the predefined subset of the bit representation of the secret value used as the input key material for deriving the encryption key and/or the authentication key is preferably different from the predefined subset of the bit representation of the secret value used as the input key material for deriving the initialization vector.

Deriving the encryption key and the authentication key from different subsets of the bit representation of the secret value may further harden the system against cryptoanalysis.

Preferably, at least part of a message authentication code, MAC, computed from the created usage data is used as a salt for deriving the initialization vector.

In this manner, different salts are used for deriving initialization vectors for different usage data items, thus effectively resulting in different keys for encrypting these usage data items.

Preferably, a first part of an output key material generated by the key derivation function is used as the encryption key and a second part of the output key material different from the first part is used as the authentication key.

In this manner, a single call to the key derivation function suffices for generating both the encryption key and the authentication key.

Preferably, the controller and/or the method is adapted for transmitting the encrypted usage data together with an authentication code of the encrypted usage data via a communication unit to an external device.

In this manner, the external device can verify the authentication code for the encrypted data in order to authenticate the transmitted usage data.

In the context of this disclosure, the external device may be any device that can be coupled communicatively to the aerosol-generating device, such as a charging station, a docking station, a mobile terminal, a personal computer, a host computer, and a server. Further, a data communication between the aerosol-generating device and the external device may be based on any suitable communication protocol and/or medium, including but not limited to, a data cable, near field communication, Bluetooth, BLE, and WiFi, etc.

According to a third aspect of the present invention, there is provided an aerosol-generating system comprising an aerosol-generating device according to the first aspect of the invention, a database configured to store a unique identification value of each of a plurality of aerosol-generating devices in association with a secret value of the aerosol-generating device, and a server. The server is configured to receive, from the aerosol-generating device, encrypted usage data and a unique identification value of the aerosol-generating device, to use the unique identification value to retrieve the secret value that is associated with the unique identification value from the database, and to decrypt the encrypted usage data using the retrieved secret value.

Providing a database that stores the unique identification value of each of a plurality of aerosol-generating devices in association with the respective secret value, allows the server to use the unique identification value received from an aerosol-generating device to retrieve the corresponding secret value. Once the server is in possession of the secret value, encrypted data received from an aerosol-generating device can be decrypted. In this manner, a secure exchange can be established between the aerosol-generating device and the server without establishing an encrypted secure channel, without including the secret value in any of the messages exchanged between the server and the aerosol-generating device, and without implementing complex algorithms for a secure key exchange.

According to a fourth aspect of the present invention, there is provided a method for manufacturing an aerosol-generating device according to the first aspect of the invention. The method comprises the steps of generating a secret value and a unique identification value, writing the secret value and the unique identification value into the storage unit of the aerosol-generating device, and storing, for each of a plurality of aerosol-generating devices, the secret value in association with the unique identification value in a database.

By providing each aerosol-generating device with a secret value and a unique identification value, the aerosol-generating device may encrypt its usage data with a device-specific key. At the same time, the aerosol-generating device may identify itself in a communication session with a server by means of the unique identification value. Storing the unique identification value of each of a plurality of aerosol-generating devices in association with the respective secret value in a database, allows the server to use the unique identification value received from an aerosol- generating device to retrieve the corresponding secret value and to use the retrieved secret value for decrypting the usage data. In this manner, a secure exchange can be performed between the aerosol-generating device and the server without establishing an encrypted secure channel, without including the secret value in any of the messages exchanged between the server and the aerosol-generating device, and without implementing complex algorithms for a secure key exchange.

Preferably, the unique identification value comprises at least one of a product identifier, a platform identifier, a unique device identifier and a manufacturing site identifier.

Providing, as the unique identification value, product-related information instead of or in combination with a unique device identifier, such as a serial number, allows the server to readily understand what kind of aerosol-generating device it is communicating with.

Preferably, the secret value is a random number generated by the aerosol-generating device during a manufacturing stage.

Using a random number as the secret value has the advantage that the secret value of an aerosol-generating device cannot be derived from a (leaked) secret value of another aerosol-generating device, thus further hardening the system against possible cryptographic attacks. Generating the secret value during a manufacturing stage of the aerosol-generating device allows that appropriate precautions are taken in order to secure this piece of sensitive information.

The method may also comprises the step of transmitting the generated random number from the aerosol-generating device to a host computer, preferably in encrypted form. The host computer may then take care of storing the secret value in association with the unique identification value in the database.

According to a fifth aspect of the present invention, there is provided a method for transmitting usage data from an aerosol-generating device to a host. The aerosol-generating device has stored therein a secret value and a unique identification value. The method comprises the steps of receiving the unique identification value from the aerosol-generating device at the host, retrieving the secret value of the aerosol-generating device from a database having stored therein the secret value of each of a plurality of aerosol-generating devices in association with the respective unique identification value. The method also comprises the step of deriving, at the host, an encryption key from at least the retrieved secret value and, optionally, the received unique identification value. The method further comprises the steps of receiving encrypted usage data from the aerosol-generating device at the host, and decrypting the received encrypted usage data with the encryption key.

By transmitting only the unique identification value from the aerosol-generating device to the host and retrieving the secret value of the aerosol-generating device from the database, a secure exchange of data can be performed between the aerosol-generating device and the host without establishing an encrypted secure channel, without including the secret value in any of the messages exchanged between the host and the aerosol-generating device, and without implementing complex algorithms for a secure key exchange.

Preferably, the method further comprises the steps of deriving, at the host, an authentication key from at least the retrieved secret value and, optionally, the unique identification value, receiving a first message authentication code, MAC, together with the encrypted usage data from the aerosol-generating device at the host, computing a second MAC from the decrypted usage data and the derived authentication key, and comparing the first MAC and the second MAC.

Computing a second MAC at the host from the decrypted usage data and comparing this MAC with the first MAC received together with the encrypted usage data, allows the host to authenticate the received usage data, to detect inadvertent modifications to the received usage data, and to thwart spoofing attacks by a malicious device.

Preferably, the method further comprises the step of deriving an initialization vector, wherein the received encrypted usage data is decrypted by applying a block cipher in counter mode using the encryption key and the initialization vector. Moreover, the initialization vector may preferably be derived from the unique identification value, the secret value, and the first MAC.

In this manner, encrypted usage data can be decrypted even if the aerosol-generating device applies a block cipher in counter mode, which is a secure method for applying a block cypher to variable-length data blocks and allows for a low-complexity implementation both at the encoder and the decoder side. Preferably, the encrypted usage data is included in a payload section of a data record having a unique record identifier. In this case, the initialization vector may preferably be derived from the unique identification value, the secret value, the first MAC, and the unique record identifier.

In this manner, the unique record identifier can be used for requesting a specific piece of usage information from the aerosol-generating device and/or for further improving data security by effectively using different keys for different data records.

According to a sixth aspect of the present invention, there is provided a host computer with a processing unit and a memory having stored thereon computer-readable instructions that are adapted, when executed by the processing unit, to perform all steps of a method according to the fifth aspect of the present invention.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device, comprising a storage unit having stored therein a secret value and a unique identification value; a communication unit; and a controller configured to create usage data indicative of usage of the aerosol-generating device, to derive an encryption key from at least the stored secret value and, optionally, the unique identification value, to encrypt the created usage data with the derived encryption key, to store the encrypted usage data in the storage unit, and to transmit the encrypted usage data and, optionally, the unique identification value via the communication unit to an external device.

Example Ex2: An aerosol-generating device according to Ex1, wherein controller is further configured to derive an authentication key from at least the secret value and, optionally, the unique identification value, and to authenticate the stored usage data with the derived authentication key.

Example Ex3: An aerosol-generating device according to any of the preceding examples, wherein the unique identification value comprises at least one of a product identifier, a platform identifier, a unique device identifier and a manufacturing site identifier.

Example Ex4: An aerosol-generating device according to any of the preceding examples, wherein the secret value is a random value generated during a manufacturing stage of the aerosol-generating device.

Example Ex5: An aerosol-generating device according to any of the preceding examples, comprising a sensor for detecting an operational state of the aerosol-generating device.

Example Ex6: An aerosol-generating device according to the preceding example, wherein the controller is configured to create the usage data based on the detected operational state.

Example Ex7: An aerosol-generating device according to the preceding example, wherein the sensor comprises one of a sensor configured for detecting a user interaction with the aerosol-generating device, a sensor configured for detecting a puff performed by a user of the aerosol-generating device, a sensor configured for detecting a voltage, a current, a resistance, a charge, an energy or a temperature related to an aerosol generating unit of the aerosol-generating device, a sensor for detecting a voltage, a current, a resistance, a charge, an energy or a temperature related to a power supply of the aerosol-generating device, a sensor for detecting a voltage, a current, a resistance, a charge, an energy or a temperature related to a charging device connected to the aerosol-generating device, a sensor for detecting a type or an amount of a consumable material used by the aerosol generating unit.

Example Ex8: An aerosol-generating device according to any of the preceding examples, wherein the usage data comprises an indication of at least one of a start time, a duration, an end time, or a type of a user interaction; a start time, a duration, or an end time of a puff or a number of puffs performed by a user of the aerosol-generating device; a start time, a duration, or an end time of a charging operation or a number of charging operations performed by the user by connecting the aerosol-generating device to a charging device; a voltage, a current, a resistance, a charge, an energy or a temperature related to an aerosol generating unit of the aerosol-generating device at a start of a puff, during the puff, or at the end of a puff performed by a user of the aerosol-generating device; a voltage, a current, a resistance, a charge, an energy or a temperature related to a power supply of the aerosol-generating device at a start of a puff, during the puff, or at the end of the puff performed by a user of the aerosol-generating device; a voltage, a current, a resistance, a charge, an energy or a temperature related to the power supply of the aerosol-generating device at a start of a charging operation, during the charging operation, or at the end of the charging operation; a type or an amount of a consumable material used by the aerosol generating unit.

Example Ex9: An aerosol-generating device according to any of the preceding examples, wherein the controller is configured to store the encrypted usage data in a payload section of a data record.

Example Ex10: An aerosol-generating device according to the preceding example, wherein each data record comprises a header, the payload section, and an authentication section.

Example Ex11: An aerosol-generating device according to the preceding example, wherein each header comprises a first data field indicating a format of the data record and a second data field indicating a length of the data record.

Example Ex12: An aerosol-generating device according the previous example, wherein each data record is associated with a record index.

Example Ex13: An aerosol-generating device according to the preceding example, wherein each header further comprises a third data field indicating how many times a record index has rolled over.

Example Ex14: An aerosol-generating device according to any of the preceding examples, wherein the controller is configured to employ a symmetric-key algorithm for encrypting the created usage data.

Example Ex15: An aerosol-generating device according to the preceding example, wherein AES is employed as the symmetric-key algorithm.

Example Ex16: An aerosol-generating device according to any of the preceding examples, wherein the controller is further configured to derive an initialization vector from the secret value and/or the unique identification value, and to encrypt the created usage data by applying a block cipher in counter mode using the encryption key and the initialization vector.

Example Ex17: An aerosol-generating device according to the preceding example, wherein the controller is configured to employ a hash-based key derivation function, HKDF, for deriving the initialization vector from the secret value and/or the unique identification value.

Example Ex18: An aerosol-generating device according to the preceding example, wherein the controller is configured to derive the initialization vector from the secret value and/or the unique identification value with a salt that comprises at least one of a predefined value, a value of a record index associated with a data record containing the created usage data, a type of the data record, and at least part of a message authentication code, MAC, computed from the created usage data.

Example Ex19: An aerosol-generating device according to any of the preceding examples, wherein the controller is further configured to authenticate the created usage data by computing a message authentication code, MAC, for the created usage data.

Example Ex20: An aerosol-generating device according to the preceding example, wherein the controller is further configured to compute the MAC for the created usage data from the created usage data and from a first authentication key.

Example Ex21: An aerosol-generating device according to any of the preceding examples, wherein the controller is further configured to authenticate the encrypted usage data by computing a MAC for the encrypted usage data.

Example Ex22: An aerosol-generating device according to the preceding example, wherein the controller is further configured to compute the MAC for the encrypted usage data from the encrypted usage data and from a second authentication key.

Example Ex23: An aerosol-generating device according to the preceding example, wherein the controller is further configured to compute the MAC for the encrypted usage data from the encrypted usage data, from the MAC for the created usage data, and from the second authentication key.

Example Ex24: An aerosol-generating device according to any of examples Ex20-Ex23, wherein the controller is further configured to derive the first authentication key and/or the second authentication key from the secret value and/or the unique identification value.

Example Ex25: An aerosol-generating device according to any of examples Ex19-Ex24, wherein the controller is further configured to employ a hash function for computing the MAC for the created usage data and/or the MAC for the encrypted usage data.

Example Ex26: An aerosol-generating device according to the preceding example, wherein the controller is further configured to compute the MAC for the created usage data and/or the MAC for the encrypted usage data by truncating an output of a hash function to a predefined number of bytes.

Example Ex27: An aerosol-generating device according to any of examples E19-Ex26, wherein the controller is further configured to store the MAC for the created usage data and/or the MAC for the encrypted usage data together with the encrypted usage data in the storage unit.

Example Ex28: An aerosol-generating device according to any of the preceding examples, wherein the controller is further configured to employ a hash-based key derivation function, HKDF, for deriving, from the secret value and/or the unique identification value, at least one of the encryption key for encrypting the created usage data, the initialization vector for encrypting the created usage data with a block cipher in counter mode, and the authentication key for authenticating the usage data.

Example Ex29: An aerosol-generating device according to the preceding example, wherein at least part of the secret value and/or the unique identification value is used as an input key material for the key derivation function.

Example Ex30: An aerosol-generating device according to the preceding example, wherein a salt is used together with the at least part of the secret value and/or the unique identification value as the input key material for the key derivation function. Example Ex31: An aerosol-generating device according to examples Ex28-Ex30, wherein a predefined subset of a bit representation of the secret value is used, together with the unique identification value and a salt, as an input key material for the key derivation function.

Example Ex32: An aerosol-generating device according to the preceding example, wherein the predefined subset of the bit representation of the secret value used as the input key material for deriving the encryption key and/or the authentication key is different from the predefined subset of the bit representation of the secret value used as the input key material for deriving the initialization vector.

Example Ex33: An aerosol-generating device according to any of examples Ex28-Ex32, wherein a fixed salt is used for deriving the encryption key and/or the authentication key.

Example Ex34: An aerosol-generating device according to any of examples Ex28-Ex33, wherein at least part of a message authentication code, MAC, computed from the created usage data is used as a salt for deriving the initialization vector.

Example Ex35: An aerosol-generating device according to any of examples Ex28-Ex34, wherein a first part of an output key material generated by the key derivation function is used as the encryption key and a second part of the output key material different from the first part is used as the authentication key.

Example Ex36: An aerosol-generating device according to any of the preceding examples, wherein the controller is further configured for transmitting the encrypted usage data together with an authentication code of the encrypted usage data via the communication unit.

Example Ex37: An aerosol-generating device according to any of the preceding examples, wherein the external device is either one of a charging station, a docking station, a mobile terminal, a personal computer, a host computer, and a server.

Example Ex38: An aerosol-generating device according to any of the preceding examples, wherein the encrypted usage data is transmitted via either one of a data cable, near field communication, Bluetooth, BLE, and WiFi.

Example Ex39: An aerosol-generating system comprising: an aerosol-generating device according to any of examples Ex1 to Ex38; a database configured to store a unique identification value of each of a plurality of aerosol-generating devices in association with a secret value of the aerosol-generating device; and a server configured to receive, from the aerosol-generating device, encrypted usage data and a unique identification value of the aerosol-generating device, to use the unique identification value to retrieve the secret value that is associated with the unique identification value from the database, and to decrypt the encrypted usage data using the retrieved secret value.

Example Ex40: A method for operating an aerosol-generating device, said method comprising the steps: storing a secret value and a unique identification value in a storage unit of the aerosol generating device; creating usage data indicative of usage of the aerosol-generating device; deriving an encryption key from at least the stored secret value; encrypting the created usage data with the derived encryption key; storing the encrypted usage data in the storage unit; and transmitting the encrypted usage data and, optionally, the unique identification value via a communication unit to an external device.

Example Ex41: A method according to Ex40, further comprising the steps: deriving an authentication key from at least the secret value and, optionally, the unique identification value; and authenticating the stored usage data with the derived authentication key.

Example Ex42: A method according to any of the preceding examples, wherein the unique identification value comprises at least one of a product identifier, a platform identifier, a unique device identifier and a manufacturing site identifier.

Example Ex43: A method according to any of the preceding examples, further comprising generating a random value as the secret value during a manufacturing stage of the aerosol-generating device.

Example Ex44: A method according to any of the preceding examples, comprising the step of detecting an operational state of the aerosol-generating device.

Example Ex45: An aerosol-generating device according to the preceding example, wherein the usage data is created based on the detected operational state.

Example Ex46: A method according to the preceding example, wherein detecting the operational state comprises at least one of detecting a user interaction with the aerosol-generating device; detecting a puff performed by a user of the aerosol-generating device; detecting a voltage, a current, a resistance, a charge, an energy or a temperature related to an aerosol generating unit of the aerosol-generating device; detecting a voltage, a current, a resistance, a charge, an energy or a temperature related to a power supply of the aerosol-generating device; detecting a voltage, a current, a resistance, a charge, an energy or a temperature related to a charging device connected to the aerosol-generating device; and detecting a type or an amount of a consumable material used by the aerosol generating unit.

Example Ex47: A method according to any of the preceding examples, wherein the usage data comprises an indication of at least one of a start time, a duration, an end time, or a type of a user interaction; a start time, a duration, or an end time of a puff or a number of puffs performed by a user of the aerosol-generating device; a start time, a duration, or an end time of a charging operation or a number of charging operations performed by the user by connecting the aerosol-generating device to a charging device; a voltage, a current, a resistance, a charge, an energy or a temperature related to an aerosol generating unit of the aerosol-generating device at a start of a puff, during the puff, or at the end of a puff performed by a user of the aerosol-generating device; a voltage, a current, a resistance, a charge, an energy or a temperature related to a power supply of the aerosol-generating device at a start of a puff, during the puff, or at the end of the puff performed by a user of the aerosol-generating device; a voltage, a current, a resistance, a charge, an energy or a temperature related to the power supply of the aerosol-generating device at a start of a charging operation, during the charging operation, or at the end of the charging operation; and a type or an amount of a consumable material used by the aerosol generating unit.

Example Ex48: A method according to any of the preceding examples, wherein the encrypted usage data is stored in a payload section of a data record.

Example Ex49: A method according to the preceding example, wherein each data record comprises a header, the payload section, and an authentication section.

Example Ex50: A method according to the preceding example, wherein each header comprises a first data field indicating a format of the data record and a second data field indicating a length of the data record.

Example Ex51: A method according the preceding example, wherein each data record is associated with a record index.

Example Ex52: A method according to the preceding example, wherein each header further comprises a third data field indicating how many times a record index has rolled over.

Example Ex53: A method according to any of the preceding examples, wherein a symmetric-key algorithm is employed for encrypting the created usage data.

Example Ex54: A method according to the preceding example, wherein AES is employed as the symmetric-key algorithm.

Example Ex55: A method according to any of the preceding examples, further comprising the steps of deriving an initialization vector from the secret value and/or the unique identification value; and encrypting the created usage data by applying a block cipher in counter mode using the encryption key and the initialization vector.

Example Ex56: A method according to the preceding example, wherein a hash-based key derivation function, HKDF, is employed for deriving the initialization vector from the secret value and/or the unique identification value.

Example Ex57: A method according to the preceding example, wherein the initialization vector is derived from the secret value and/or the unique identification value with a salt that comprises at least one of a predefined value, a value of a record index associated with a data record containing the created usage data, a type of the data record, and at least part of a message authentication code, MAC, computed from the created usage data.

Example Ex58: A method according to any of the preceding examples, further comprising the step of authenticating the created usage data by computing a message authentication code, MAC, for the created usage data.

Example Ex59: A method according to the preceding example, wherein the MAC for the created usage data is computed from the created usage data and from a first authentication key.

Example Ex60: A method according to any of the preceding examples, further comprising the step of authenticating the encrypted usage data by computing a MAC for the encrypted usage data.

Example Ex61: A method according to the preceding example, wherein the MAC for the encrypted usage data is computed from the encrypted usage data and from a second authentication key.

Example Ex62: A method according to the preceding example, further comprising the step of computing the MAC for the encrypted usage data from the encrypted usage data, from the MAC for the created usage data, and from the second authentication key.

Example Ex63: A method according to any of examples Ex59-Ex62, further comprising the step of deriving the first authentication key and/or the second authentication key from the secret value and/or the unique identification value.

Example Ex64: A method according to any of examples Ex58-Ex63, wherein a hash function is employed for computing the MAC for the created usage data and/or the MAC for the encrypted usage data.

Example Ex65: A method according to the preceding example, wherein the MAC for the created usage data and/or the MAC for the encrypted usage data is computed by truncating an output of a hash function to a predefined number of bytes.

Example Ex66: A method according to any of examples Ex58-Ex65, further comprising the step of storing the MAC for the created usage data and/or the MAC for the encrypted usage data together with the encrypted usage data.

Example Ex67: A method according to any of the preceding examples, further comprising the step of employing a hash-based key derivation function, HKDF, for deriving, from the secret value and/or the unique identification value, at least one of the encryption key for encrypting the created usage data, the initialization vector for encrypting the created usage data with a block cipher in counter mode, and the authentication key for authenticating the usage data.

Example Ex68: A method according to the preceding example, wherein at least part of the secret value and/or the unique identification value is used as an input key material for the key derivation function.

Example Ex69: A method according to the preceding example, wherein a salt is used together with the at least part of the secret value and/or the unique identification value as the input key material for the key derivation function.

Example Ex70: A method according to example Ex67, wherein a predefined subset of a bit representation of the secret value is used, together with the unique identification value and a salt, as an input key material for the key derivation function.

Example Ex71: A method according to the preceding example, wherein the predefined subset of the bit representation of the secret value used as the input key material for deriving the encryption key and/or the authentication key is different from the predefined subset of the bit representation of the secret value used as the input key material for deriving the initialization vector.

Example Ex72: A method according to any of examples Ex67-Ex71, wherein a fixed salt is used for deriving the encryption key and/or the authentication key.

Example Ex73: A method according to any of examples Ex67-Ex72, wherein at least part of a message authentication code, MAC, computed from the created usage data is used as a salt for deriving the initialization vector.

Example Ex74: A method according to any of examples Ex67-Ex73, wherein a first part of an output key material generated by the key derivation function is used as the encryption key and a second part of the output key material different from the first part is used as the authentication key.

Example Ex75: A method according to any of the preceding examples, wherein the encrypted usage data is transmitted together with an authentication code of the encrypted usage data.

Example Ex76: A method according to any of the preceding examples, wherein the external device is either one of a charging station, a docking station, a mobile terminal, a personal computer, a host computer, and a server.

Example Ex77: A method according to any of the preceding examples, wherein the encrypted usage data is transmitted via either one of a data cable, near field communication, Bluetooth, BLE, and WiFi.

Example Ex78: A method for manufacturing an aerosol-generating device according to any of the preceding examples, said method comprising: generating a secret value and a unique identification value; writing the secret value and the unique identification value into the storage unit of the aerosol-generating device; and storing, for each of a plurality of aerosol-generating devices, the secret value in association with the unique identification value in a database.

Example Ex79: A method according to the preceding example, wherein the unique identification value comprises at least one of a product identifier, a platform identifier, a unique device identifier and a manufacturing site identifier.

Example Ex80: A method according to example Ex78 or Ex79, wherein the secret value is a random number generated by the aerosol-generating device during a manufacturing stage.

Example Ex81: A method according to the preceding example, further comprising transmitting the generated random number from the aerosol-generating device to a host computer.

Example Ex82: A method according to the preceding example, wherein the generated random number is transmitted from the aerosol-generating device to the host computer in encrypted form.

Example Ex83: A method for transmitting usage data from an aerosol-generating device to a host, the aerosol-generating device having stored therein a secret value and a unique identification value, said method comprising the steps: receiving the unique identification value from the aerosol-generating device at the host; retrieving the secret value of the aerosol-generating device from a database having stored therein the secret value of each of a plurality of aerosol-generating devices in association with the respective unique identification value; deriving, at the host, an encryption key from at least the retrieved secret value and, optionally, the received unique identification value; receiving encrypted usage data from the aerosol-generating device at the host; and decrypting the received encrypted usage data with the encryption key.

Example Ex84: The method according to the preceding example, further comprising deriving, at the host, an authentication key from at least the retrieved secret value and, optionally, the unique identification value; receiving a first message authentication code, MAC, together with the encrypted usage data from the aerosol-generating device at the host; computing a second MAC from the decrypted usage data and the derived authentication key; and comparing the first MAC and the second MAC.

Example Ex85: The method according to the preceding example, further comprising deriving an initialization vector, wherein the received encrypted usage data is decrypted by applying a block cipher in counter mode using the encryption key and the initialization vector.

Example Ex86: The method according to the preceding example, wherein the initialization vector is derived from the unique identification value, the secret value, and the first MAC.

Example Ex87: The method according to the preceding example, wherein the encrypted usage data is included in a payload section of a data record having a unique record identifier.

Example Ex88: The method according to the preceding example, wherein the initialization vector is derived from the unique identification value, the secret value, the first MAC, and the unique record identifier.

Example Ex89: A host computer with a processing unit and a memory having stored thereon computer-readable instructions that are adapted, when executed by the processing unit, to perform all steps of a method according to any of examples Ex83-Ex88.

Examples will now be further described with reference to the figures in which:

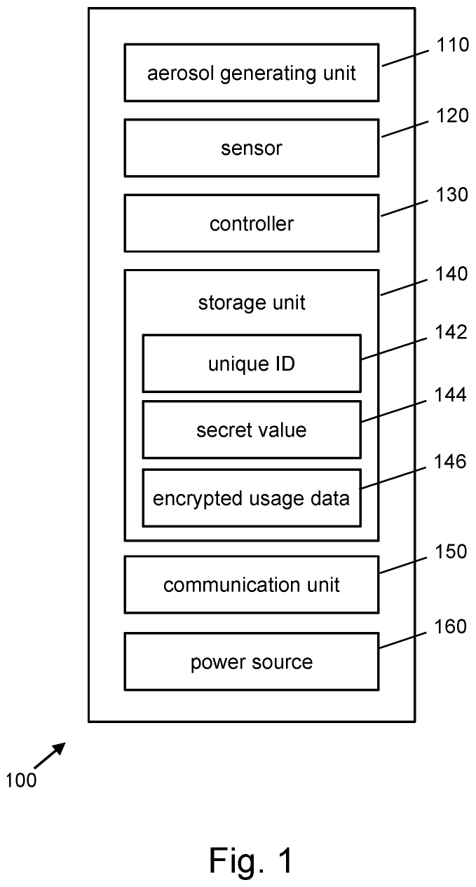

FIG. 1 shows a block diagram of an aerosol generating device according to an embodiment;

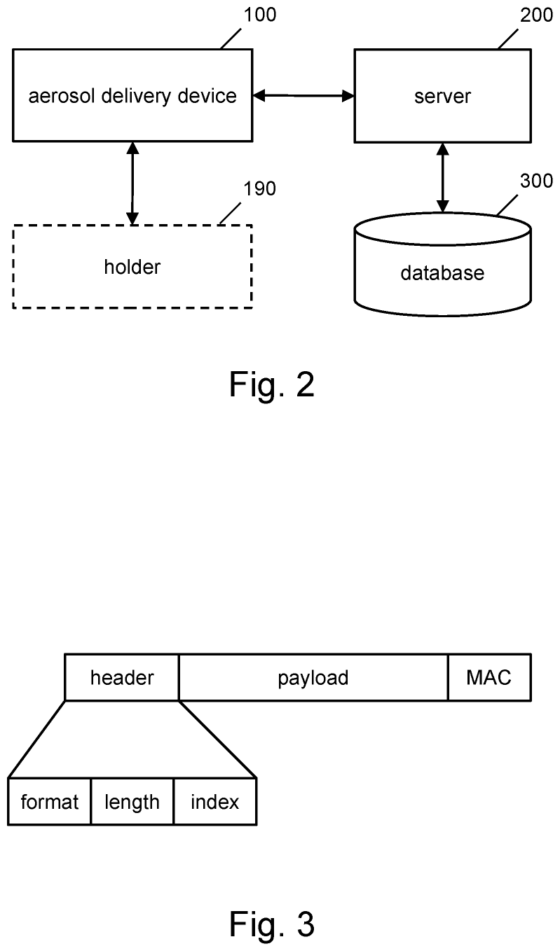

FIG. 2 shows a block diagram of a system comprising an aerosol generating device and a server according to an embodiment;

FIG. 3 shows a schematic representation of a data structure according to an embodiment;

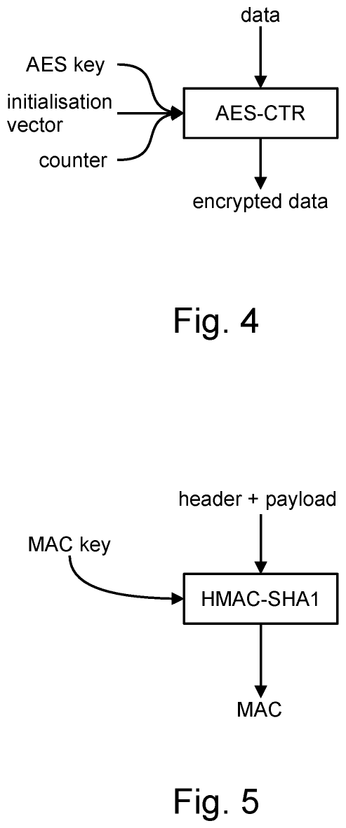

FIG. 4 shows a diagram illustrating the data flow in a method for encrypting usage data according to an embodiment;

FIG. 5 shows a diagram illustrating the data flow in a method for calculating a MAC according to an embodiment;

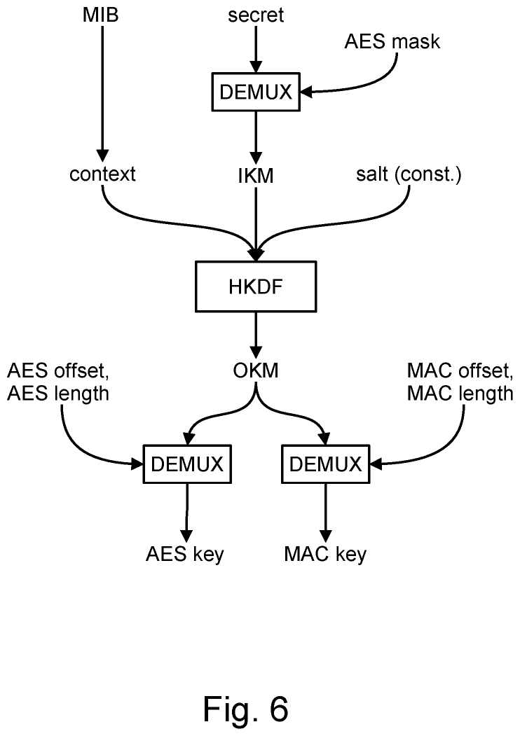

FIG. 6 shows a diagram illustrating the data flow in a method for deriving encryption and authentication keys according to an embodiment;

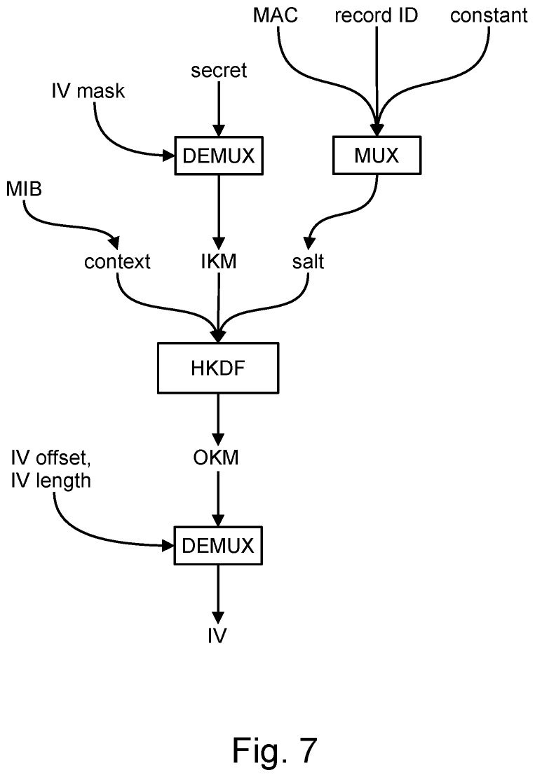

FIG. 7 shows a diagram illustrating the data flow in a method for deriving the initial vector according to an embodiment;

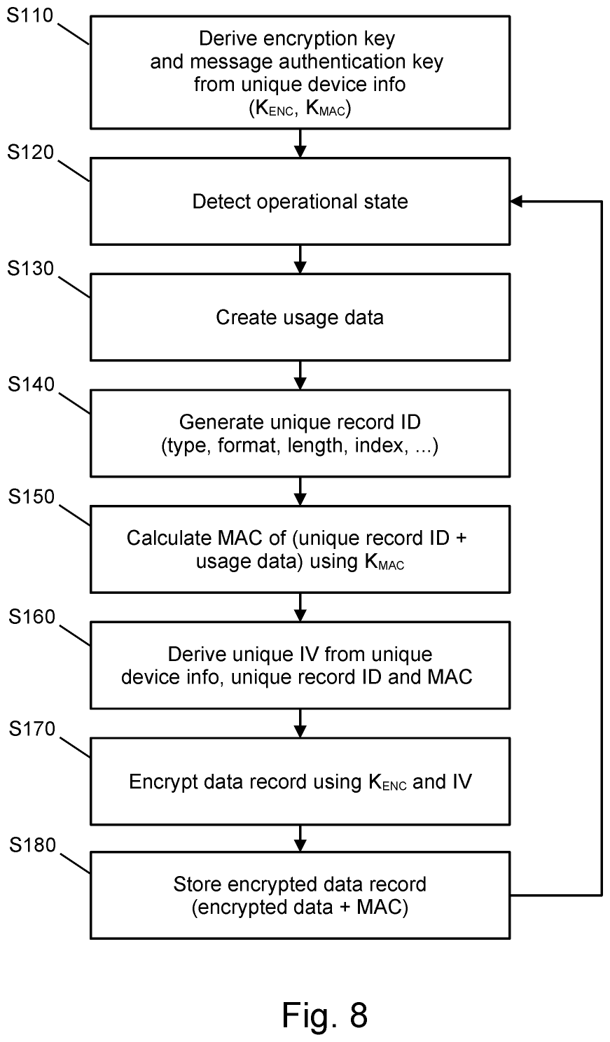

FIG. 8 shows a flow chart of a method for encrypting usage data according to an embodiment;

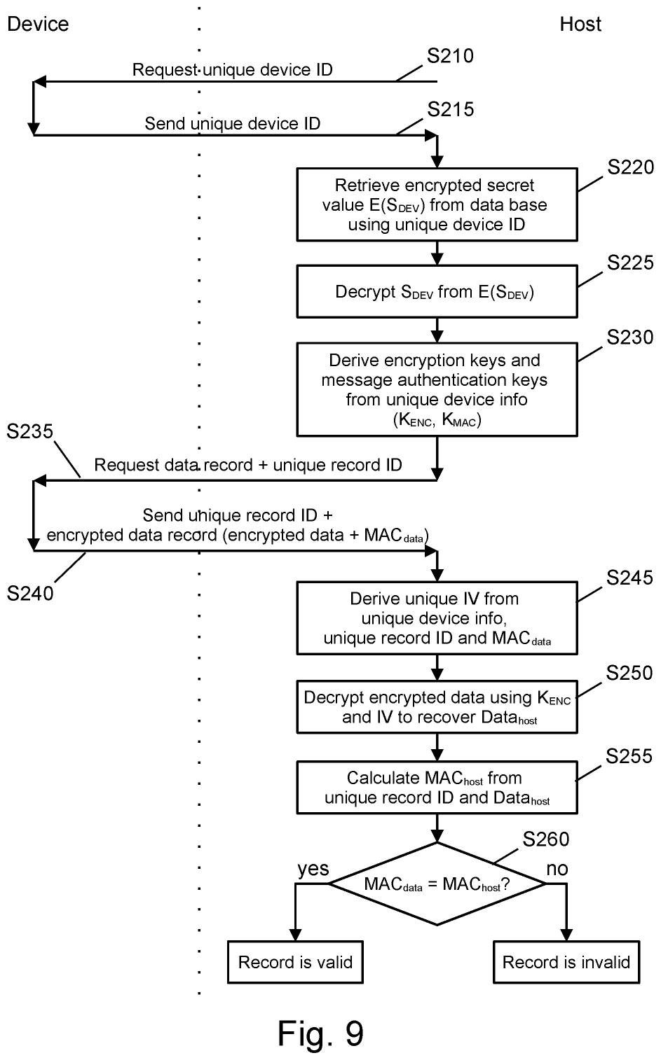

FIG. 9 shows a flow chart of a method for transmitting and decrypting usage data according to an embodiment;

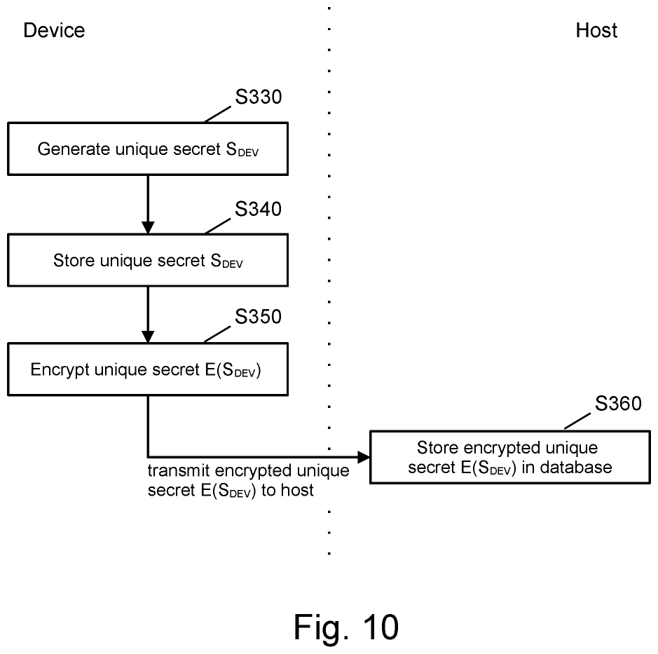

FIG. 10 shows a flow chart of a manufacturing method according to an embodiment; and

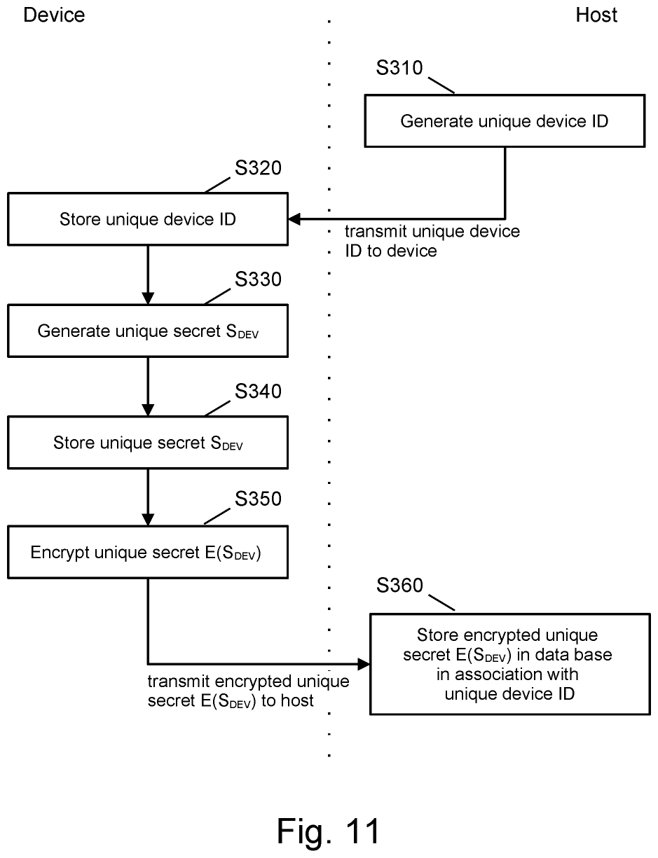

FIG. 11 shows a flow chart of a manufacturing method according to a further embodiment.

FIG. 1 shows a block diagram of an aerosol-generating device (100) according to an embodiment of the present invention. The aerosol-generating device (100) may comprise an aerosol-generating unit (110), a sensor (120), a communication unit sensor (130), a storage unit (140), a communication unit (150), and a power source (160).

The aerosol-generating unit (110) is a unit for generating an aerosol for inhalation by a user of the aerosol-generating device from a precursor material (consumable material). As an example, the aerosol-generating unit (110) may comprise a vaporizer or a heating element. The precursor material may be provided in liquid or solid form. The aerosol-generating unit (110) is powered by electric energy provided by power source (160) and controlled by controller (130).

The sensor (120) delivers data that may be used for controlling operation of the aerosol-generating device. For example, the sensor may be configured for detecting a user interaction with the aerosol-generating device, such as pressing a button, opening or closing of a receptacle for the precursor material, performing a gesture by moving the device in a particular manner, etc. The sensor may also be configured for detecting a puff performed by a user of the aerosol-generating device. In another example, the sensor may be configured for detecting a voltage, a current, a resistance, a charge, an energy or a temperature related to an operation of the aerosol-generating unit (110). The sensor may also be configured for detecting a voltage, a current, a resistance, a charge, an energy or a temperature related to a power source (160) of the aerosol-generating device and/or a charging device connected to the aerosol-generating device. In a further example, the sensor may be configured for detecting a type or an amount of a consumable material used by the aerosol-generating unit (110).

The controller (130) is in charge of controlling the overall operation of the aerosol-generating device, in particular of operating the aerosol-generating unit (110), possibly on the basis of data delivered by the sensor (120), creating, encrypting and storing usage data in the storage unit (140), receiving and transmitting data via the communication unit (150), monitoring and/or controlling a charging of the power source (160), etc. The controller (130) may be a microprocessor, a microcontroller, or a combination of more than one microprocessor and/or microcontroller. The controller (130) may also be provided with a storage for storing computer program instructions and/or a memory for storing data related to the execution of a computer program.

The storage unit (140) is connected to the controller (130) and has stored therein a unique identifier (142) and a secret value (144), which may be used by the controller for encrypting usage data. The storage unit (140) is further adapted for storing the encrypted usage data created by the controller (130). The storage unit may be volatile or non-volatile. As an example, a flash memory is provided as the storage unit. The storage unit may be an integral part of a microcontroller or a component external to the controller. The storage unit may comprise more than one physically or logically separated storage sections or components for storing different data items. The unique identifier (142), the secret value (144), and the encrypted usage data (144), for instance, may be stored in different sections or components of the storage unit (140). The secret value may be stored in a section or component that is specifically secured against unauthorized access.

The unique identifier (142) is a piece of data unique for each aerosol-generating device, e.g. a unique device identity. For example, each aerosol-generating device may be provided with a unique serial number stored as the unique identifier in the storage unit (140). The unique identifier may also include, in addition to or instead of the serial number, information indicating at least one of a product identifier, a platform identifier, and a manufacturing site. The unique identifier may also be provided as a unique manufacturing information block (or a manufacturing facility ID), MIB, i.e., as a data block comprising information pertaining to the manufacturing process, such as a product ID, a platform ID, a unique ID (or a serialized device unit ID) and a manufacturing site.

The secret value (144) is a value used by the controller for deriving an encryption key for encrypting the usage data. The secret value is secret in the sense that it is generally neither known to the user or any other unauthorized persons nor (readily) derivable from the aerosol-generating device or the transmitted data. The secret value is also not included in any data transmissions during regular operation. The secret value may be stored in a particularly secured part of the storage unit (140) that is not accessible for any external devices.

The secret value is also stored, in association with the respective unique identifier, in a database accessible for a manufacturer server. In this manner, the server may use the unique identifier in a look-up operation to obtain the secret value of a particular aerosol-generating device in order to derive the encryption key that was used for encrypting the device's usage data. Using the thus derived encryption key, the server may decrypt the encrypted usage data transmitted from this particular device.

The secret value may be sufficiently large in order to prevent a brute-force attack on the encrypted data. For example, the secret value may comprise 8, 16, 32, 64, 128 or 256 bytes of data. Other sizes for the secret value, including sizes that are a power of two or different from a power of two, may also be used.

By way of example, a random number or a pseudo random number generated during the manufacturing process may be used as the secret value. The secret value may be generated by the aerosol-generating device during the manufacturing process and transmitted, preferably in encrypted form, to a host computer which takes care of storing the secret value in association with the unique identifier in a database for later reference by a manufacturer server. The secret value may also be generated by the host computer and transmitted to or directly written into the storage unit (140) during a stage of the manufacturing process.

The encrypted usage data (146) is usage data created by the controller and stored in the storage unit (140) in encrypted form. The usage data indicates usage of the aerosol-generating device and may be data generated by the device in response to a particular event. Examples include data generated due to a device error, aerosol generation or battery recharge. For example, the usage data may comprise an indication of at least one of a start time, a duration, an end time, and a type of an interaction performed by the user with the aerosol-generating device, such as pressing a button, opening or closing of a receptacle for the precursor material, performing a gesture by moving the device in a particular manner, etc. The usage data may also comprise an indication of at least one of a start time, a duration, and an end time of a puff or a number of puffs performed by the user of the aerosol-generating device. The usage data may also comprise an indication of at least one of a start time, a duration, and an end time of a charging operation or a number of charging operations performed by the user by connecting the aerosol-generating device to a charging device.

The usage data may also pertain to an operational state or a health state of the aerosol-generating device (100). For example, the usage data may also comprise an indication of at least one of a voltage, a current, a resistance, a charge, an energy and a temperature related to the aerosol-generating unit (110) of the aerosol-generating device. The usage data may also comprise an indication of at least one of a voltage, a current, a resistance, a charge, an energy or a temperature related to the power source (160) of the aerosol-generating device. Each of these indications may be conditioned to a specific event, such as the start of a puff, during the puff, or the end of the puff performed by a user of the aerosol-generating device. At least some these indications may also be conditioned to the start, the duration, or the end of a heating operation performed by the aerosol-generating unit (110) and/or to a start of a charging operation, the during the charging operation, or the end of the charging operation. The usage data may also indicate a type or an amount of a consumable material used by the aerosol-generating unit.

The communication unit (150) is configured for establishing a communication link to an external device, and in particular for transmitting encrypted usage data (146) to a manufacturer server. The communication link may be based on any wired or wireless communication technique, including, but not limited to, a serial communication link, a universal serial bus (USB), an optical communication port, near-field communication (NFC), Bluetooth, Bluetooth low energy (BLE), wireless communication, WiFi according to any of the IEEE 802.11x standards, mobile communication, etc. Communication with the manufacturer server may be direct or indirect, for instance via an intermediate device such as a mobile phone, a holder or a docking station. Communication with the manufacturer server may also involve more than only one communication protocol, such as for example a Bluetooth connection between the aerosol- generating device and a mobile phone and mobile communication between the mobile phone and an Internet access point.

The power source (160) supplies electric power to all components of the aerosol-generating device. The power source may be a rechargeable battery, such as lithium ion battery or a lithium polymer battery. Other power sources may be used as well.

FIG. 2 shows a block diagram of a system comprising an aerosol-generating device (100) and a server (200) according to an embodiment of the present invention. The aerosol-generating device (100) and the server (200) are connected by a communication link for transmitting encrypted usage data. The server (200) has access to a database (300) that stores the secret value for each of a plurality of aerosol-generating devices in association with the respective unique identifier. The aerosol-generating device may also be connected to a holder (190) or docking station that operates as a charging device (190) for charging power source (160). The communication link between the aerosol-generating device (100) and the server (200) may also be formed indirectly with the holder (190) or a mobile phone operating as an intermediary (not shown).

FIG. 3 shows a schematic representation of a data structure according to an embodiment of the present invention. Usage data may be stored and transmitted in form of data records, wherein each data record pertains to a specific event, such as user interaction, charging operation, temperature, battery level, error message, etc. Each data record may comprise a header, a payload section, and an authentication section (message authentication code, MAC). The header may specify a format of the data record, a length of the data record, and an index. The format may indicate what data is provided at what position within the payload section. Different formats may be predefined for different events. The length may indicate the overall length of the data record or the length of the payload section.

The index, or the index together with other elements of the header, in particular the length, the data type and the data format, may form a unique identifier (Record Unique Identity, RUID) of the corresponding data record. The record index may be unique, based on either an incrementing number, or a combination of a small incrementing number which may be repeated and a “rollover” value indicating the number of times the smaller number has overflowed. The index is not necessarily stored and/or transmitted together with the payload and may be implicitly known either from a request for a specific data record or the position of the data record within an array or list of data records. Hence, instead of the index value, the roll-over value may be stored and/or transmitted that indicates how many times the index has rolled over a predefined maximum index value.

The payload may contain the actual usage data, i.e., the information pertaining to the respective event, as explained above in connection with FIG. 1. The payload may be encrypted. The MAC may be a cryptographic signature or authentication code used for authentication purposes. The processes for data encryption, authentication and key derivation will be explained below.

According to the present invention, a symmetric key algorithm is used for encrypting the usage data stored in the payload of each data record. Since the payload length may vary and will generally exceed a block size of conventional block cipher algorithms, counter mode is applied in order to convert the conventional block cipher into a stream cipher. Counter mode, as it is generally known in the art, generates a key stream by encrypting successive values of a counter. The ciphertext is then obtained by XORing the plaintext with the key stream. In order to ensure that a different key stream is used for each data record, the counter is concatenated with a nonce or initialization vector that differs from data record to data record. Decryption is then performed by XORing the ciphertext with the same key stream again.

In a preferred embodiment, the Advanced Encryption Standard (AES) is used in counter mode (AES-CTR) for encrypting the usage data. The data flow for encrypting the usage data according to this embodiment is illustrated in FIG. 4.

The AES-CTR algorithm receives usage data as an input and delivers encrypted usage data as an output. The encryption process may further require, apart from the encryption key (AES key), a counter and an initialisation vector for the counter mode.

According to a further aspect of the present invention, authenticity of each usage data record is guaranteed by an authentication code (digital signature), or “digest”. This signature is provided in form of a message authentication code (MAC) computed from the header and/or the payload of the data record. Any modification to the data record will result (with overwhelming probability) in a MAC different from the MAC of the original data record, so that tampered data can easily be detected (integrity check). Moreover, computation of the MAC is based on a secret key (authentication key or MAC key) so that an attacker cannot predict the “correct” MAC for a given piece of data. In this manner, the system is hardened against spoofing attacks that try to pollute the manufacturer server with false or corrupt information (authenticity check).

In a preferred embodiment, a hash-based MAC (HMAC) is employed, i.e., a MAC that is computed by applying a cryptographic hash algorithm, preferably the Secure Hash Algorithm 1 (SHA-1), to the data that is to be authenticated. The algorithm for computing a MAC based on the SHA-1 is commonly referred to as HMAC-SHA1. Other algorithms may be used as well, including HMAC-SHA256.

FIG. 5 shows a diagram illustrating the data flow in a method for calculating the MAC according to an embodiment of the present invention. The HMAC-SHA1 algorithm receives the header and the payload of a data record together with the MAC key as an input and delivers the MAC as an output.

Generally, the strength of an authentication code, or “digest” depends on its length. The HMAC-SHA1 algorithm, for instance, delivers a MAC with a length of 160 bits (20 bytes). In an aerosol-generating device, however, a large number of short data records with only a few bytes per record need to be authenticated. Attaching a 20 bytes MAC to each record is thus impracticable, especially in view of the limited amount of storage capacity available in aerosol-generating devices.

In order to reduce the overhead for storage and transmission of authenticated data records, and to increase the maximum number of data records that can be stored within the aerosol-generating device, the MAC delivered by the HMAC algorithm may be truncated to a few bytes, e.g., to 2, 3, or 4 bytes. Such a use of truncated authentication codes increases the number of collisions for a maliciously crafted encrypted record. However, in such case, attempts to pollute the manufacturer servers with false data shall be detected due to either impossible data or multiple data logs which have a false authentication code.

Both the encryption key (AES key) and the message authentication key (MAC key) are derived from the secret value and the unique ID stored in the aerosol-generating device. Different aerosol-generating devices thus use different keys for encrypting and authenticating their data records. Therefore, even if a particular device is compromised so that its AES and/or MAC keys become known, the other devices will not be affected.

A key derivation function based on the HMAC algorithm (HKDF) is used for deriving both the AES key and the MAC key. A key derivation function (KDF) is a cryptographic algorithm that derives one or more secret keys from a secret value and can be used to stretch keys into longer keys or to obtain keys of a required format. The HKDF algorithm extracts a pseudo-random key (PRK) using an HMAC hash function (e.g. HMAC-SHA256) on an optional salt (acting as a key for the HMAC function) and any potentially weak input key material (IKM) (acting as data). It then generates similarly cryptographically strong output key material (OKM) of any desired length by repeatedly generating PRK-keyed hash-blocks and then appending them into the output key material, finally truncating to the desired length.

The data flow for this process is illustrated in FIG. 6. The HKDF algorithm receives (a subset of the bits of) the secret value as the input key material, the unique identifier (UID) as the context and a constant value as the salt and delivers the output key material (OKM). A mask (AES mask) is used to select (de-multiplex) a subset of bits from the secret value as the IKM. A different mask (IV mask) is used for selecting a different subset of bits from the secret value as the IKM for deriving the initialisation vector, as will be explained below in conjunction with FIG. 7. Both the AES key and the MAC key are obtained from the OKM by selecting the required number of consecutive bits (AES length, MAC length) from different positions (AES offset, MAC offset) within the OKM.

The initialisation vector for encrypting the usage data with AES-CTR is also derived from the secret value and the UID by means of a key derivation function similar to that used for deriving the AES key and the MAC key. In order to further strengthen this method against crypto-analysis, the initialisation vector is also made dependent on the current data record, in particular on the MAC of the (unencrypted) usage data stored in the payload section of the data record and/or a unique identifier (RUID) of the data record, such as an index or a sequence number, and/or other properties of the payload to be encrypted. In this manner, a different initialisation vector can be used for each data record and/or each transmission without increasing the size of the data record any further.

The data flow for this process is illustrated in FIG. 7. The HKDF algorithm receives (a subset of the bits of) the secret value as the input key material (IKM), the unique identifier (UID) as the context and a combination of the (truncated) MAC, the record identifier and a constant value as the salt and delivers the output key material (OKM). The combination of the (truncated) MAC, the record identifier and the constant value may be obtained, for example, by concatenating the respective bit strings in a multiplexer (MUX). A mask (IV mask) is used to select (de-multiplex) a subset of bits from the secret value as the IKM. The initialisation vector is obtained at a certain position (IV offset) with the required length (IV length) from the OKM.

All input information to the key derivation function illustrated in FIG. 7, including the MAC and the unique identifier, are also available at the manufacturer server when the encrypted data record has been transmitted from the aerosol-generating device. Therefore, the server can derive the same initialisation vector and decrypt the received data record.

It is generally accepted that a MAC should be computed for the encrypted message so that authenticity can be checked before decryption starts (encrypt-then-MAC). In the present situation, however, the advantage of being able to use the MAC as an additional input to the KDF for deriving the initialisation vector may outweigh the risk of applying the decryption algorithm to data that has potentially be tampered with. Therefore, the MAC is preferably computed for the unencrypted data (MAC-then-encrypt) so that is available for the encryption process.

In a further embodiment of the present invention, a MAC may also be computed for the encrypted usage data (encrypt-then-MAC) in addition to or instead of the MAC for the unencrypted data (MAC-then-encrypt). To this end, a second authentication key may be derived from the unique device information in a manner similar to that for deriving the (first) authentication key for computing the MAC for the unencrypted data. The second authentication key may then be used for calculating a MAC for the encrypted usage data by applying the HMAC algorithm to the encrypted usage data or to the encrypted usage data and the MAC for the unencrypted data. The MAC for the encrypted usage data is then transmitted together with the encrypted message.

At the server side, integrity of the encrypted message may be checked by deriving the second authentication key in the same manner as in the aerosol-generating device, computing a server-side MAC from the encrypted message, and comparing the server-side MAC with the MAC attached to the encrypted message. The decryption process is then only started if the two MACs are identical.

FIG. 8 shows a flow chart of a method for encrypting usage data according to an embodiment of the present invention.

In step S110, an encryption key K_{ENC} and a message authentication key K_{MAC} are derived from unique device information with a key derivation process as described in conjunction with FIG. 6. In step 120 an operational state of the aerosol generating device is detected, for instance by a means of a suitable sensor. Based on the detection results, usage data is created in step S130. Depending on the kind of usage data created, a unique record ID is generated in step S140. The unique record ID may comprise information indicating a type of the data record, a format, a length and an index. In step S150 a message authentication code, MAC, is calculated for the unique record ID and the usage data using the message authentication key K_{MAC} with a process as described in conjunction with FIG. 5. In step S160, a unique initialisation vector IV is derived from the unique device information, the unique record ID and the MAC with a process as described in conjunction with FIG. 7. In step S170, the data record is encrypted using the encryption key K_{ENC} and the initialisation vector IV with a process as described in conjunction with FIG. 4. The encrypted data record is then be stored, together with the MAC, in the aerosol generating device in step 180. The process may then return to step S120.

FIG. 9 shows a flow chart of a method for transmitting usage data from an aerosol generating device to a host and decrypting the received data at the host, according to an embodiment of the present invention.

The process may be initiated by the host, which may be a manufacturer server, by transmitting a request to the aerosol generating device (S210). The aerosol generating device may respond to this request by transmitting its unique device ID, such as the manufacturing information block, MIB (S215). The secret information, on the other hand, is neither part of this transmission nor any other transmissions between the aerosol generating device and the host in the context of this process. Upon receiving the unique device ID, the host retrieves the corresponding secret value S_{DEV} from a database in step S220. The secret value may be stored in the database in encrypted form and the host may decrypt the encrypted secret value E(S_{DEV}) in step S225. At this point in time, the host is in possession of the entire unique device information, i.e., the unique device ID and the secret value, and thus in a position to derive the encryption and message authentication keys used by the aerosol generating device for encrypting and authenticating the usage data. Specifically, the host derives, in step S230, the encryption key K_{ENC} and the message authentication key K_{MAC} from the unique device information with the same key derivation process as performed by the aerosol generating device and described in conjunction with FIG. 6.

In step S235, the host may request data from the aerosol generating device. The request may comprise an indication of one or more data records that are to be send by the aerosol generating device, such as at least a part of a unique record ID or a range of index values, etc. The aerosol generating device may respond to this request by transmitting the requested data record in encrypted form, together with the corresponding MAC_{data} (S240). The response may also comprise the unique record ID of each data record sent.

In step S245, the host derives the unique initialisation vector IV from the unique device information, the unique record ID and the MACDATA with the same process as performed by the aerosol generating device and described in conjunction with FIG. 7. The initialisation vector IV is then used in step S250 together with the encryption key K_{ENC} to decrypt the received data record and to recover the data DATAₕₒₛₜ contained therein.

In step S255, the host calculates a message authentication code MACₕₒₛₜ from the unique record ID and the recovered data DATAₕₒₛₜ. If the thus calculated message authentication code MACₕₒₛₜ is found, in step S260, to be identical to the message authentication code MAC_{data} received together with the encrypted data record, then the record is considered to be valid. If not, the data record is invalid.

FIG. 10 shows a flow chart of a manufacturing method for an aerosol generating device according to an embodiment of the present invention. The steps of this method may be performed at a certain stage of the assembling process of the aerosol generating device or final testing of the assembled aerosol generating device, for example upon first power-up of the controller 130.

In step S330, the aerosol generating device generates a unique secret value S_{DEV}, for instance, by means of a random number generator. The thus generated secret value S_{DEV} is then stored in the storage unit 140 of the aerosol generating device as part of the unique device information (S340), encrypted (S350) and transmitted to a host computer in order to be stored in a database for future reference (S360).

FIG. 11 shows a flow chart of a manufacturing method for an aerosol generating device according to a further embodiment of the present invention. The steps of this method may be performed at a certain stage of the assembling process of the aerosol generating device or final testing of the assembled aerosol generating device, for example upon first power-up of the controller 130.

The process according to FIG. 11 differs from that of FIG. 10 by additional steps S310 and S320. In step S310, the host generates a unique device ID and transmits same to the aerosol generating device. The unique device ID may comprise a unique manufacturing information block, MIB, i.e., a data block comprising information pertaining to the manufacturing process, such as a product ID, a platform ID, a unique ID and a manufacturing site, as explained above.

In step S320, the aerosol generating device stores the received unique device ID in the storage unit 140. In step S330, the aerosol generating device generates a unique secret value S_{DEV}, for instance, by means of a random number generator. The thus generated secret value S_{DEV} is then stored in the storage unit 140 of the aerosol generating device together with the unique device ID (S340). In step S530, the secret value S_{DEV} is encrypted and transmitted to the host computer in order to be stored in the database in association with the unique device ID for later retrieval (S360).

Embodiments of the present invention thus provide a technique for protecting the usage data stored in aerosol-generating devices, both inside the device and upon transmission to external devices, such as manufacturer servers. Moreover, manufacturer servers collecting data from aerosol-generating devices are protected from being polluted with false or corrupted information. Embodiments of the present invention can protect storage and transmission of usage data in aerosol-generating devices without requiring a public key infrastructure or overly complex algorithms for secure key exchange. Embodiments of the present invention further provide a high degree of data security even in systems with a large number aerosol-generating devices and a large number of individual data records. Embodiments of the present invention are also specifically adapted to the limited computational power and storage capacity of aerosol-generating devices.

1.-15. (canceled)

16. An aerosol-generating device, comprising:
a storage unit having stored therein a secret value generated during a manufacturing stage of the aerosol-generating device and a unique identification value;
a communication unit; and
a controller configured to:
create usage data indicative of usage of the aerosol-generating device,
derive an encryption key from at least the stored secret value,
encrypt the created usage data with the derived encryption key,
store the encrypted usage data in the storage unit, and
transmit the encrypted usage data and the unique identification value via the communication unit to an external device, the unique identification value identifying the secret value used for deriving the encryption key.

17. The aerosol-generating device according to claim 16, wherein the controller is further configured to derive the encryption key from at least the unique identification value.

18. The aerosol-generating device according to claim 16, wherein the controller is further configured to derive an authentication key from at least the secret value and to authenticate the stored usage data with the derived authentication key.

19. The aerosol-generating device according to claim 16, wherein the controller is further configured to derive the authentication key from at least the secret value and the unique identification value, and to authenticate the stored usage data with the derived authentication key.

20. The aerosol-generating device according to claim 16, wherein the controller is further configured to employ a symmetric-key algorithm for encrypting the created usage data.

21. The aerosol-generating device according to claim 16, wherein the controller is further configured to derive an initialization vector from the secret value and/or the unique identification value, and to encrypt the created usage data by applying a block cipher in counter mode using the encryption key and the initialization vector.

22. The aerosol-generating device according to claim 16, wherein the controller is further configured to authenticate the created usage data by computing a message authentication code (MAC) for the created usage data.

23. The aerosol-generating device according to claim 16, wherein the controller is further configured to authenticate the encrypted usage data by computing a message authentication code (MAC) for the encrypted usage data.

24. The aerosol-generating device according to claim 22, wherein the controller is further configured to compute the MAC for the created usage data by truncating an output of a hash function to a predefined number of bytes.

25. The aerosol-generating device according to claim 23, wherein the controller is further configured to compute the MAC for the encrypted usage data by truncating an output of a hash function to a predefined number of bytes.

26. The aerosol-generating device according to claim 22, wherein the controller is further configured to store the MAC for the created usage data together with the encrypted usage data in the storage unit.

27. The aerosol-generating device according to claim 23, wherein the controller is further configured to store the MAC for the encrypted usage data together with the encrypted usage data in the storage unit.

28. The aerosol-generating device according to claim 16, wherein the controller is further configured to employ a hash-based key derivation function (HKDF) for deriving, from the secret value and/or the unique identification value, at least one of the encryption key for encrypting the created usage data, the initialization vector for encrypting the created usage data with a block cipher in counter mode, and the authentication key for authenticating the usage data.

29. The aerosol-generating device according to claim 28, wherein at least part of a message authentication code (MAC) computed for the created usage data is used as a salt for deriving the initialization vector.

30. An aerosol-generating system, comprising:
an aerosol-generating device according to claim 16;
a database configured to store a unique identification value of each of a plurality of aerosol-generating devices in association with a secret value of the aerosol-generating device; and
a server configured to:
receive, from the aerosol-generating device, encrypted usage data and a unique identification value of the aerosol-generating device,
use the unique identification value to retrieve the secret value that is associated with the unique identification value from the database, and
decrypt the encrypted usage data using the retrieved secret value.

31. A method for operating an aerosol-generating device, the method comprising the steps of:
storing a secret value generated during a manufacturing stage of the aerosol-generating device and a unique identification value in a storage unit of the aerosol generating device;
creating usage data indicative of usage of the aerosol-generating device;
deriving an encryption key from at least the stored secret value;
encrypting the created usage data with the derived encryption key;
storing the encrypted usage data in the storage unit; and
transmitting the encrypted usage data and the unique identification value via a communication unit to an external device, the unique identification value identifying the secret value used for deriving the encryption key.

32. The method according to claim 31, wherein the deriving the encryption key further comprises deriving the encryption key from the unique identification value.

33. A method for transmitting usage data from an aerosol-generating device to a host, the aerosol-generating device having stored therein a secret value and a unique identification value, the method comprising the steps of:
receiving the unique identification value from the aerosol-generating device at the host;
retrieving the secret value of the aerosol-generating device from a database having stored therein the secret value of each of a plurality of aerosol-generating devices in association with the respective unique identification value;
deriving, at the host, an encryption key from at least the retrieved secret value;
receiving, at the host, encrypted usage data from the aerosol-generating device; and
decrypting the received encrypted usage data with the encryption key.

34. The method according to claim 33, wherein the deriving the encryption key further comprises deriving the encryption key from the received unique identification value.

35. The method according to claim 33, further comprising:
deriving, at the host, an authentication key from at least the retrieved secret value;
receiving a first message authentication code (MAC) together with the encrypted usage data from the aerosol-generating device at the host;
computing a second MAC from the decrypted usage data and the derived authentication key; and
comparing the first MAC and the second MAC.

36. The method according to claim 34, further comprising:
deriving, at the host, an authentication key from the unique identification value;
receiving a first message authentication code (MAC) together with the encrypted usage data from the aerosol-generating device at the host;
computing a second MAC from the decrypted usage data and the derived authentication key; and
comparing the first MAC and the second MAC.

37. The method according to claim 35,
further comprising deriving an initialization vector,
wherein the received encrypted usage data is decrypted by applying a block cipher in counter mode using the encryption key and the initialization vector.

38. The method according to claim 36,
further comprising deriving an initialization vector,
wherein the received encrypted usage data is decrypted by applying a block cipher in counter mode using the encryption key and the initialization vector.
